(19) United States
(12) Patent Application Publication
(10) Pub. No.: US 2004/0060211 A1
(43) Pub. Date: Apr. 1, 2004

(54) Display for collectibles

(76) Inventors: Diane Lynn Thomas, Queensville (CA); Linda Joy McClure, Georgetown (CA)

Correspondence Address: MILLER THOMPSON, LLP, 20 QUEEN STREET WEST, SUITE 2500, TORONTO, ON, M5H 3S1, CA

(21) Appl. No.: 10/435,459

(22) Filed: May 12, 2003

Related U.S. Application Data
(60) Provisional application No. 60/413,746, filed on Sep. 27, 2002.

(51) Int. Cl. G09F 1/00

(52) U.S. Cl. 40/124.11

(57) ABSTRACT

A display for collectibles includes a first portion or wall and second portion or wall. The first and second walls are joined at one end thereof and together provide a self-supporting structure. Each of the first wall and second wall has a display surface. The display surface is puncturable for mounting one or more display pins in a variety of positions and patterns. The display surface is also suitable for display of photographs, labels, stickers and the like, or any combinations thereof.

### FIELD OF THE INVENTION

This invention relates in general to a display for pins and other collectible items. This invention relates more particularly to a self-supporting display for pins and other collectible items.

### BACKGROUND OF THE INVENTION

Prior art pin displays are known. For example, U.S. Des. Pat. No. 405,296 issued to Komarov on Apr. 16, 1991 shows a pin display having a display surface with a curved bottom portion. The display surface includes an aperture for receiving a pin. The display surface is supported by a flat bottom wall. Opposite to the display surface is a back surface with a recess. The aperture extends from the display surface to the recess whereby the length of the aperture generally corresponds to the length of a pin.

U.S. Des. Pat. No. 316,197 issued to Baker on Feb. 9, 1991 in regard to a “Pin Display or Similar Article”. The pin display of the present invention includes a display surface with a plurality of equally spaced apart apertures covering substantially all of the display surface. The wall that includes the display surface is supported by a flat base.

U.S. Pat. No. 4,739,886 issued to Seaberg on Apr. 26, 1998 for a “Pierced Earring Holder”. The display surface includes a plurality of spaced apart apertures. The wall that includes the display surface is supported by a base that includes a slot for receiving the display surface and supporting the display surface in an upright position.

A display for collectible items having a simple self-supporting structure is required. A display is required for showing collectible items such as pins, stickers, collectible cards, ribbons, photographs, plaques and labels. More particularly, a display for collectible items is required that permits a plurality of different arrangements of pins, stickers, collectible cards, ribbons, photographs, plaques, and labels.

### SUMMARY OF THE INVENTION

An object of one aspect of the present invention is to provide an improved display for pins and other collectible items.

An object of another aspect of the present invention is a self-supporting display that permits the display of different arrangements of pins and other collectible items.

### BRIEF DESCRIPTION OF THE DRAWINGS

A detailed description of particular embodiments are provided herein below by way of example only and with reference to the following drawings, in which:

FIG. 1 is a perspective view of the display of the present invention, in one embodiment thereof;

FIG. 1a is a partial cross-sectional view of the display along line 1a-1a shown in FIG. 1;

FIG. 2 is a second perspective view of the embodiment of the present invention shown in FIG. 1; and

FIG. 3 is a perspective view of a second embodiment of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

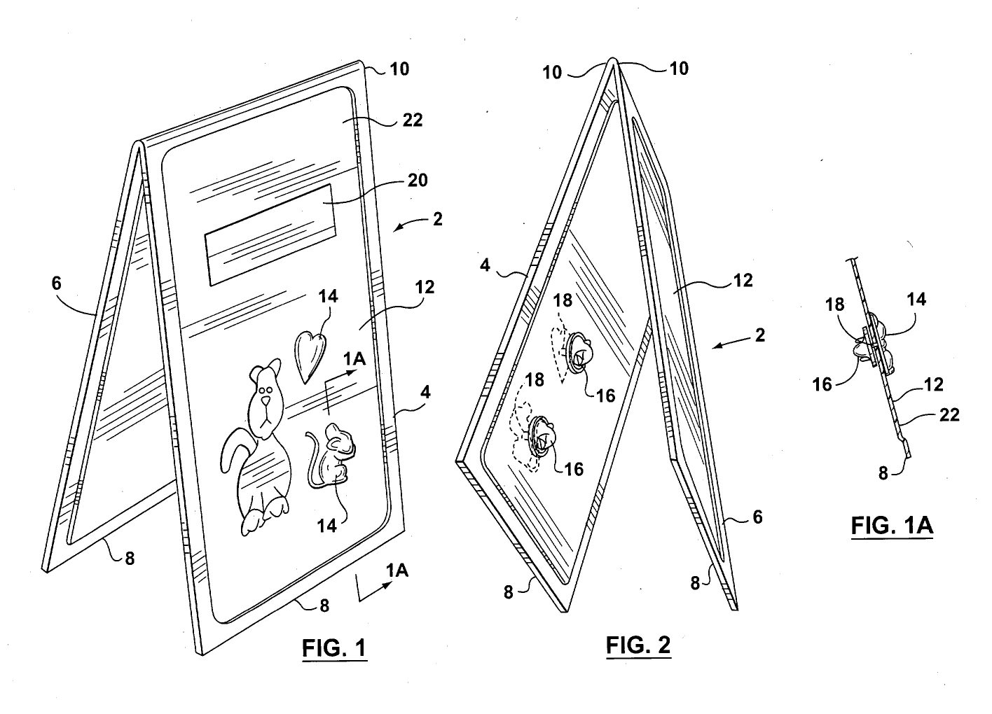

Referring to FIG. 1, there is illustrated in a perspective view, a self-supporting display in accordance with an embodiment of the present invention.

The display 2 includes a first portion or first wall 4 and second portion or second wall 6. Each of the first wall 4 and second wall 6 has a first end 8 and second end 10. At the first end 8, the second wall 6 and first wall 4 are spaced apart. At the second end 10, the second wall 6 and first wall 4 are generally connected. This connection may consist of said first wall 4 and second wall 6 being integral at one end, or alternatively a hinge means may be used to connect the first wall 4 and second wall 6.

When the display 2 is placed on a flat surface (such as a desk or shelf) such that the first end 8 of each of the second wall 6 and first wall 4 are disposed adjacent to the flat surface, the display is self-supporting. In the embodiments of the present invention shown in FIGS. 1-3, this is achieved because the first wall 4 and second wall 6 are substantially of the same length and are connected at the second end 10 such that a cross-section of the display along its length corresponds substantially in profile to an isosceles triangle. It should be understood, however, that other self-supporting structure where the first wall 4 and second wall 6 are of different lengths are also possible, without departing from the present invention.

At least one of the first wall 4 and second wall 6 includes a display surface 12 for receiving collectible items such as pins, stickers, photographs, collectible cards, ribbons and the like. In one embodiment of the present invention, both the first wall 4 and the second wall 6 includes a display surface 12 whereby users can display their collectible items on both the first wall 4 and he second wall 6, as described below, if they so choose. A user may decide, however, to display collectible items only on the first wall 4.

The display surface 12 is provided such that it can be perforated relatively easily using the pin portion of a pin of the well known collectible type having a face 14 integral with a pin, and a back 16 that is adapted to releasably engage the pin shaft 18, as best shown in FIG. 1a. It should be understood that back 16 shown in FIG. 1a is a representative illustration of a pin back, and other types of back are also contemplated. The display surface 12 may comprise a number of materials that permit perforation by such a pin, including for example plastic. In a particular embodiment of the present invention, PVC is used to provide the display surface 12, manufactured in a manner that is known. The thickness of each display surface 12 is provided such that the display surface 12 is readily manually puncturable using a pin. In view of the size of the dimensions of the average collectible pin, in a representative embodiment of the present invention, this was achieved with a display surface 12 made of PVC having a thickness of approximately 0.08 inch. It should be understood that alternate puncturable materials such as cardboard can also be used.

The advantage of the puncturable display surface 12 is that not every user will want to display the same number of pins, the same sized pins, in the same configuration. To this end, a puncturable display surface 12 is more desirable than providing a series of apertures on a display surface 12 in that unused or uncovered apertures may interfere with the aesthetic impression of the display overall. Thus, the display 2 of the present invention may be readily tailored, including on an ongoing basis, to suit particular aesthetic or organizational objectives in displaying collectible items and/or labels.

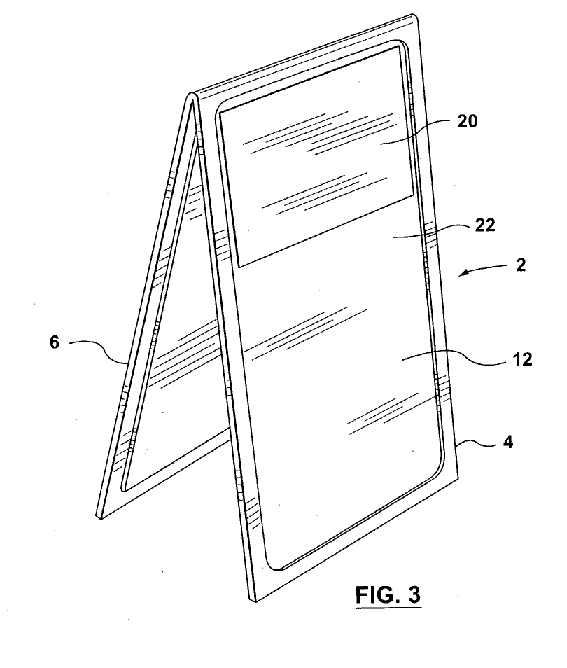

In another aspect of the present invention, each display surface 12 has a selected thickness. The thickness of the material is selected so as to permit relatively rigid mounting of pins on the display surface 12, as best shown in FIG. 2. The pin shaft 18 is manually forced through the first wall 4 or second wall 6 that includes the display surface 12. The pin shaft 18 is thereby forced across to the other side of the first wall 4 or second wall 6. The thickness of the display surface 12 is selected such that the length of the pin shaft 18 thus extending to the other side of the first wall 4 or second wall 6 permits the back 16 to be attached to the end of the pin shaft 18 distal to the face 14, as shown in FIG. 2. The thickness of the display surface 12 is further selected so that once the back 16 is so attached to the pin shaft 18 the second wall of the face 14 and the back 16 frictionally engage the first wall 4 or second wall 6 providing the display surface 12 such that, for example, the face 14 does not tend to rotate once the pin is mounted on the first wall 4 or second wall 6 providing the display surface 12.

As best shown in FIG. 1, the display surface 12 may be used to mount a plurality of pins. In addition, to pins, a variety of other collectible items such as collectible cards (e.g. hockey cards, baseball cards), and photographs can be attached to the display surface 12 using a suitable adhesive. Stickers can also be adhered to the display surface 12. Various arrangements including combinations of the foregoing collectible items are possible.

Also, as shown in FIG. 1, a label 20 can also be attached to the display surface 12, also using an adhesive. The label 20 may include a sticker or an engraved plaque. The label 20 may include text to personalize a display 2, for example, an engraved plaque including the name of an intended recipient. In this way, it should be understood that the display of the present invention can be used to mount a label 20 and one or more pins, stickers or photographs to provide a trophy of sorts.

Graphic material such as designs or text can also be printed or screened on the display surface 12, in a manner that is known. Such graphic material may include promotional material or designs that correspond with a particular use of the present invention. For example, in relation to use of the present invention as a promotional item sold by pet stores, for example, paw prints or the like can be screened on the display surface 12.

The display surface 12 can also be provided in a manner that the display can be personalized by drawing on a surface suitable for drawing. The display surface 12 itself in this case is provided such that it is suitable to be drawn upon using a drawing implement of some sort, or alternatively a sticker providing a drawing surface is applied to the display surface 12.

The label 20 can also be used to include promotional information such as the name of a vendor providing the display 2 such that the display can be used as promotional item.

In an embodiment of the invention illustrated in FIG. 3, the display surface includes a recess 22, having a representative size and shape. The recess 22 may receive a label (not shown), preferably sized to fit within the recess 22. The recess 22 permits a label 20 having a thickness to be attached to the display surface 12 whilst being disposed substantially in the same plane as the rest of the display surface 12.

It should also be understood that the display surfaces 12 may consist of a variety of different shapes in addition to the generally rectangular profile illustrated in the drawings. For example, one or each of the display surfaces 12 may be provided with a profile such as that of a Christmas tree or some other design in a manner that is known.

1) A display for collectibles comprising:
a) A first portion;
b) A second portion connected to the first portion at one end thereof,
wherein the first portion and second portion define a self-supporting structure; and
wherein at least one of said first portion and second portion defines a display surface for receiving collectibles.

2) The display claimed in claim 1, wherein said display surface consists of a material manually puncturable by a pin.

3) The display claimed in claim 2, wherein each of the first portion and second portion includes a display surface.

4) The display claimed in claim 3, wherein the pin consists of a pin portion and a back, and wherein the display surface is puncturable such that a pin can be mounted on the display surface by puncturing a first side of the display surface with the pin portion, and connecting the back to the pin portion protruding at a second side of the display surface opposite to the first side of the display surface.

5) The display claimed in claim 4, wherein the display surface is of a selected thickness adapted to maintain a pin in a fixed position on the display surface when said pin is mounted on the display surface.

6) The display claimed in claim 5, wherein said collectibles consist of one or more articles including pins, stickers, photographs, collectible cards and ribbons.

7) The display claimed in claim 6, wherein the display surface generally consists of a material suitable for affixing articles such as labels, plaques, collectible cards or photographs using an adhesive.

8) The display as claimed in claim 7, wherein the first portion and second portion are connected by a hinge.

9) A promotional product comprising:
a) A display for collectibles comprising:
i) A first portion;
ii) A second portion connected to the first portion at one end thereof,
wherein the first portion and second portion define a self-supporting structure; and
wherein at least one of said first portion and second portion defines a display surface for receiving collectibles; and
b) A promotional message displayed in the display surface.

10) A kit for assembling a display of collectibles comprising:
a) A display for collectibles comprising:
i) A first portion;
ii) A second portion connected to the first portion at one end thereof,
wherein the first portion and second portion define a self-supporting structure; and
wherein at least one of said first portion and second portion defines a display surface for receiving collectibles; and
b) A plurality of collectibles including one or more of pins, stickers, photographs, collectible cards and ribbons whereby a user selects one or more of such pins, stickers, photographs, collectibles cards or ribbons and selectively mounts same on the display surface.
